(19) United States
(12) Patent Application Publication
(10) Pub. No.: US 2018/0052592 A1
(43) Pub. Date: Feb. 22, 2018

(54) ELECTRONIC DEVICE AND CONTROL METHOD THEREOF

(71) Applicant: SAMSUNG ELECTRONICS CO., LTD., Suwon-si (KR)

(72) Inventors: Kyunghwa SEO, Seongnam-si (KR); Jaehan LEE, Suwon-si (KR); Hoyoung LEE, Seoul (KR)

(21) Appl. No.: 15/679,381

(22) Filed: Aug. 17, 2017

(30) Foreign Application Priority Data
Aug. 18, 2016 (KR) 10-2016-0104811

(51) Int. Cl. G06F 3/0484; G06F 3/0488

(52) U.S. Cl. CPC G06F 3/04845; G06F 3/0416; G06F 3/0488

(57) ABSTRACT

An electronic device is disclosed. The electronic device includes a display and a processor. The display receives a touch input. The processor is electrically connected to the display. The processor controls an image to be displayed on the display, and controls an image effect list that includes first and second image effects to be displayed on the display. The processor adjusts a combining ratio between the first and second image effects in response to a first input, and changes the displayed image based on the adjusted combining ratio.

### CROSS-REFERENCE TO RELATED APPLICATION

This application is based on and claims priority under 35 U.S.C. §119 to a Korean patent application filed on Aug. 18, 2016, in the Korean Intellectual Property Office and assigned Serial No. 10-2016-0104811, the disclosure of which is incorporated by reference herein in its entirety.

### TECHNICAL FIELD

The present disclosure relates generally to a technique for combining a plurality of image effects applicable to an image displayed in an electronic device. For example, the present disclosure relates to an electronic device and method for adjusting a combining ratio between a plurality of image effects in response to a user input and applying combined image effects to an image.

### BACKGROUND

With a remarkable growth of the electronic communication industry, a great variety of electronic devices (also referred to as user devices) such as mobile communication terminals, smart phones, laptop computers, and wearable devices are increasingly popularized in these days. Most of such electronic devices are now providing a graphical user interface (GUI) environment based on a touch screen to allow a user to easily interact with them. In addition, the electronic devices may provide various kinds of multimedia based on a web environment.

Nearly all the electronic devices have a basic camera function and an image editing function. Further, such electronic devices may offer various image effects for an image. The user may not only instantly capture a desired moment as an image due to the portability of the electronic device, but also download a desired image at any time from a web server. Also, the user may create user's own image by applying various image effects to the captured or received image.

However, typical functions of applying image effects have drawbacks, including that it is difficult to easily adjust a combining ratio between image effects when combining various image effects.

### SUMMARY

The present disclosure provides an electronic device and control method thereof for easily combining a plurality of image effects at a desired combining ratio and applying the combined image effects to an image.

According to various example embodiments of the present disclosure, an electronic device may include a display configured to receive a touch input and a processor electrically connected to the display. The processor may be configured to control an image to be displayed on the display, to control an image effect list containing first and second image effects to be displayed on the display, to adjust a combining ratio between the first and second image effects in response to a first input, and to change the displayed image based on the adjusted combining ratio.

In the electronic device, the processor may be further configured to adjust a level of applying the first and second image effects to the image in response to a second input.

In the electronic device, each of the first and second inputs may be a touch-and-drag input.

In the electronic device, the first input may be the touch-and-drag input in a first direction and the second input may be the touch-and-drag input in a second direction different from the first direction.

In the electronic device, when changing the displayed image based on the adjusted combining ratio, the processor may be further configured to differently change a first portion of the image and a second portion of the image different from the first portion, based on a combining ratio of the first image effect.

In the electronic device, when changing the displayed image based on the adjusted combining ratio, the processor may be further configured to change a first portion of the image and to not change a second portion of the image different from the first portion, based on a combining ratio of the first image effect.

In the electronic device, the processor may be further configured to create and store a third image effect by combining the first and second image effects in response to a third input.

In the electronic device, the processor may be further configured to display the third image effect together with the first and second image effects.

In the electronic device, the image effect list may further contain a third image effect, and the processor may be further configured to adjust a combining ratio among the first, second and third image effects within a predetermined range.

In the electronic device, the image effect list may further contain a third image effect, and the processor may be further configured to adjust a combining ratio to apply cumulatively the first, second and third image effects to the image.

According to various example embodiments of the present disclosure, an electronic device control method for combining a plurality of image effects may include displaying an image, displaying an image effect list containing first and second image effects, adjusting a combining ratio between the first and second image effects in response to a first input, and changing the displayed image based on the adjusted combining ratio.

The method may further include adjusting a level of applying the first and second image effects to the image in response to a second input.

In the method, each of the first and second inputs may be a touch-and-drag input.

In the method, the first input may be the touch-and-drag input in a first direction and the second input may be the touch-and-drag input in a second direction being different from the first direction.

In the method, the changing the displayed image based on the adjusted combining ratio may include differently changing a first portion of the image and a second portion of the image different from the first portion, based on a combining ratio of the first image effect.

In the method, the changing the displayed image based on the adjusted combining ratio may include changing a first portion of the image without changing a second portion of the image different from the first portion, based on a combining ratio of the first image effect.

The method may further include creating and storing a third image effect by combining the first and second image effects in response to a third input.

The method may further include, when the plurality of image effects includes a third image effect, adjusting a combining ratio among the first, second and third image effects within a predetermined range.

The method may further include, when the plurality of image effects includes a third image effect, adjusting a combining ratio to apply cumulatively the first, second and third image effects to the image.

According to various example embodiments of the present disclosure, a non-transitory computer-readable recording medium having, recorded thereon, a program executing an electronic device control method for combining a plurality of image effects. The program may include instructions of displaying an image, displaying an image effect list containing first and second image effects, adjusting a combining ratio between the first and second image effects in response to a first input, and changing the displayed image based on the adjusted combining ratio.

The electronic device according to various example embodiments may display, on the display, the image effect list containing a plurality of image effects including the first and second image effects, adjust the combining ration between the first and second image effects in response to the user's first input, and change the displayed image based on the adjusted combining ratio. Therefore, the user may easily combine a plurality of image effects and confirm the combined result.

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example network environment according to various example embodiments of the present disclosure;

FIG. 2 is a block diagram illustrating an example electronic device according to various example embodiments of the present disclosure;

FIG. 3 is a block diagram illustrating an example program module according to various example embodiments of the present disclosure;

FIG. 4 is a block diagram illustrating an example electronic device according to various example embodiments of the present disclosure;

FIGS. 5A, 5B and 5C are diagrams illustrating an example process of combining image effects to be applied to an image in an electronic device according to various example embodiments of the present disclosure;

FIGS. 6A, 6B and 6C are diagrams illustrating an example process of adjusting a level of combined image effects in an electronic device according to various example embodiments of the present disclosure;

FIG. 7 is a flowchart illustrating an example method for combining a plurality of image effects and adjusting a level for applying the combined image effects to an image in an electronic device according to various example embodiments of the present disclosure;

FIGS. 8A, 8B and 8C are diagrams illustrating example cases of combining a plurality of image effects in an electronic device according to various example embodiments of the present disclosure;

FIGS. 9A, 9B and 9C are diagrams illustrating an example process of storing a new image effect created by combining first and second image effects in an electronic device according to various example embodiments of the present disclosure;

FIGS. 10A, 10B and 100 are diagrams illustrating an example process of applying an image effect to an image in an electronic device according to various example embodiments of the present disclosure;

FIGS. 11A and 11B are diagrams illustrating example cases of combining three or more image effects in an electronic device according to various example embodiments of the present disclosure; and

FIGS. 12A and 12B are diagrams illustrating other example cases of combining three or more image effects in an electronic device according to various example embodiments of the present disclosure.

### DETAILED DESCRIPTION

Hereinafter, the present disclosure will be described with reference to the accompanying drawings. Although various example embodiments are illustrated in the drawings and related detailed descriptions are discussed in the present disclosure, the present disclosure may have various modifications and several embodiments. However, the various example embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. On the other hand, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a communication function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch, or the like, but is not limited thereto.

According to some embodiments, the electronic device may be a smart home appliance having a communication function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame, or the like, but is not limited thereto.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Navigation Satellite System (GNSS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops, or the like, but is not limited thereto.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a camera function, or the like, but is not limited thereto. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

According to an example embodiment of the present disclosure, a screen of an electronic device may be split into at least two windows according to a predefined split manner and displayed through a display of an electronic device. The windows may be referred, for example, to as split windows. According to an example embodiment, the split windows may refer, for example, to windows displayed on a display of an electronic display not to be superposed one on another.

According to an example embodiment, a popup window may refer, for example, to a window displayed on a display of an electronic device to hide or to be superposed on a portion of a screen under execution.

According to an example embodiment of the present disclosure, an electronic device using split window and a popup window is capable of displaying two or more application execution screens or function execution screens. Thus, the split windows and the popup window may be referred, for example, to as a multi-window.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

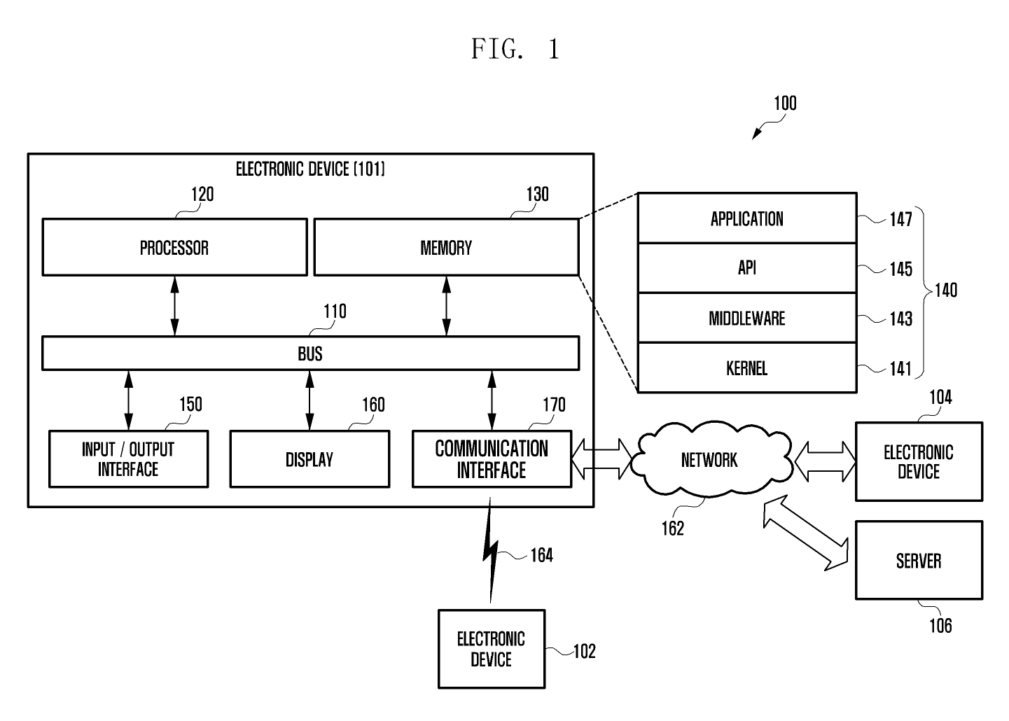

FIG. 1 is a diagram illustrating an example network environment 100 including an electronic device 101 according to various example embodiments of the present disclosure. Referring to FIG. 1, the electronic device 100 may include a bus 110, a processor (e.g., including processing circuitry) 120, a memory 130, a input/output interface (e.g., including input/output circuitry) 150, a display 160 and a communication interface (e.g., including communication circuitry) 170.

The bus 110 may be a circuit connecting the above described components and transmitting communication (for example, a control message) between the above described components. The processor 120 may include various processing circuitry and receives commands from other components (for example, the memory 130, the input/output interface 150, the display 160, the communication interface 170) through the bus 110, analyzes the received commands, and executes calculation or data processing according to the analyzed commands. The memory 130 stores commands or data received from the processor 120 or other components (for example, the input/output interface 150, the display 160, or the communication interface 170) or generated by the processor 120 or other components. The memory 130 may include programming modules 140, for example, a kernel 141, middleware 143, an Application Programming Interface (API) 145, and an application 147. Each of the aforementioned programming modules may be implemented by software, firmware, hardware, or a combination of two or more thereof.

The kernel 141 controls or manages system resources (for example, the bus 110, the processor 120, or the memory 130) used for executing an operation or function implemented by the remaining other programming modules, for example, the middleware 143, the API 145, or the application 147. Further, the kernel 141 provides an interface for accessing individual components of the electronic device 101 from the middleware 143, the API 145, or the application 147 to control or manage the components. The middleware 143 performs a relay function of allowing the API 145 or the application 147 to communicate with the kernel 141 to exchange data. Further, in operation requests received from the application 147, the middleware 143 performs a control for the operation requests (for example, scheduling or load balancing) by using a method of assigning a priority, by which system resources (for example, the bus 110, the processor 120, the memory 130 and the like) of the electronic device 100 can be used, to the application 134.

The API 145 is an interface by which the application 147 can control a function provided by the kernel 141 or the middleware 143 and includes, for example, at least one interface or function (for example, command) for a file control, a window control, image processing, or a character control. The input/output interface 150 can receive, for example, a command and/or data from a user, and transfer the received command and/or data to the processor 120 and/or the memory 130 through the bus 110. The display 160 can display an image, a video, and/or data to a user.

According to an embodiment, the display 160 may display a graphic user interface image for interaction between the user and the electronic device 100. According to various embodiments, the graphic user interface image may include interface information to activate a function for correcting color of the image to be projected onto the screen. The interface information may be in the form of, for example, a button, a menu, or an icon.

The communication interface 170 may include various communication circuitry and connects communication between the electronic device 100 and the external device (for example, electronic device 102, 104 or server 106). For example, the communication interface 160 may access a network 162 through wireless or wired communication to communicate with the external device. Additionally, the communication interface 170 may establish a short-range local-area communication connection 164 with an electronic device, e.g., electronic device 102. The wireless communication includes at least one of, for example, WiFi, BlueTooth (BT), Near Field Communication (NFC), a Global Navigation Satellite System (GNSS), and cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the server 106 supports driving of the electronic device 100 by performing at least one operation (or function) implemented by the electronic device 100. For example, the server 106 may include a communication control server module that supports the communication interface 170 implemented in the electronic device 100. For example, the communication control server module may include at least one of the components of the communication interface 170 to perform (on behalf of) at least one operations performed by the communication interface 170.

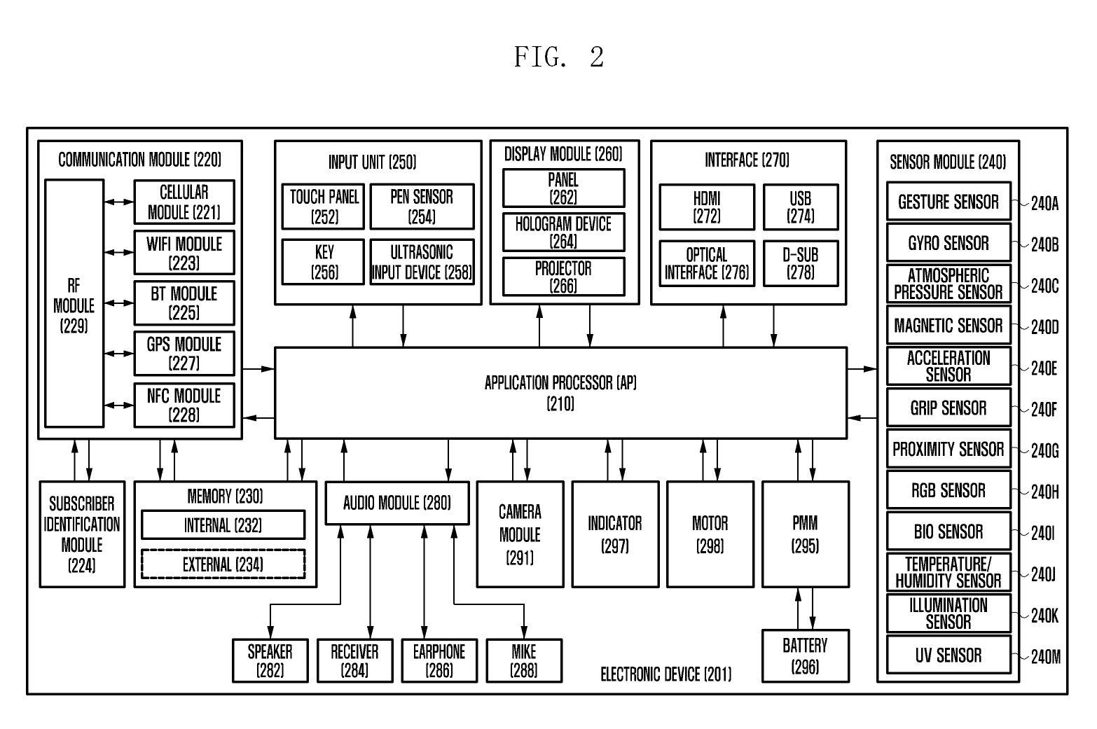

FIG. 2 is a block diagram illustrating an example electronic device 201 according to various embodiments of the present disclosure. The electronic device 201 may include, for example, a whole or a part of the electronic device 100 illustrated in FIG. 1. Referring to FIG. 2, the electronic device 201 includes one or more Application Processors (APs) (e.g., including processing circuitry) 210, a communication module (e.g., including communication circuitry) 220, a Subscriber Identification Module (SIM) card 224, a memory 230, a sensor module 240, an input device (e.g., including input circuitry) 250, a display 260, an interface (e.g., including interface circuitry) 270, an audio module 280, a camera module 291, a power managing module 295, a battery 296, an indicator 297, and a motor 298.

The AP 210 may include various processing circuitry and operates an operating system (OS) or an application program so as to control a plurality of hardware or software component elements connected to the AP 210 and execute various data processing and calculations including multimedia data. The AP 210 may be implemented by, for example, a System on Chip (SoC). According to an embodiment, the processor 210 may further include a Graphic Processing Unit (GPU).

The communication module 220 (for example, communication interface 170) may include various communication circuitry and transmits/receives data in communication between different electronic devices (for example, the electronic device 104 and the server 106) connected to the electronic device 200 (for example, electronic device 100) through a network. According to an example embodiment, the communication module 220 may include various communication circuitry, such as, for example, and without limitation, at least one of a cellular module 221, a WiFi module 223, a BlueTooth (BT) module 225, a Global Navigation Satellite System (GNSS) module 227, a Near Field Communication (NFC) module 228, and a Radio Frequency (RF) module 229.

The cellular module 221 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 may distinguish and authenticate electronic devices within a communication network by using a subscriber identification module (for example, the SIM card 224). According to an embodiment, the cellular module 221 performs at least some of the functions which can be provided by the AP 210. For example, the cellular module 221 may perform at least some of the multimedia control functions.

According to an embodiment, the cellular module 221 may include a Communication Processor (CP). Further, the cellular module 221 may be implemented by, for example, an SoC.

According to an embodiment, the AP 210 or the cellular module 221 (for example, communication processor) may load a command or data received from at least one of a non-volatile memory and other components connected to each of the AP 210 and the cellular module 221 to a volatile memory and process the loaded command or data. Further, the AP 210 or the cellular module 221 may store data received from at least one of other components or generated by at least one of other components in a non-volatile memory.

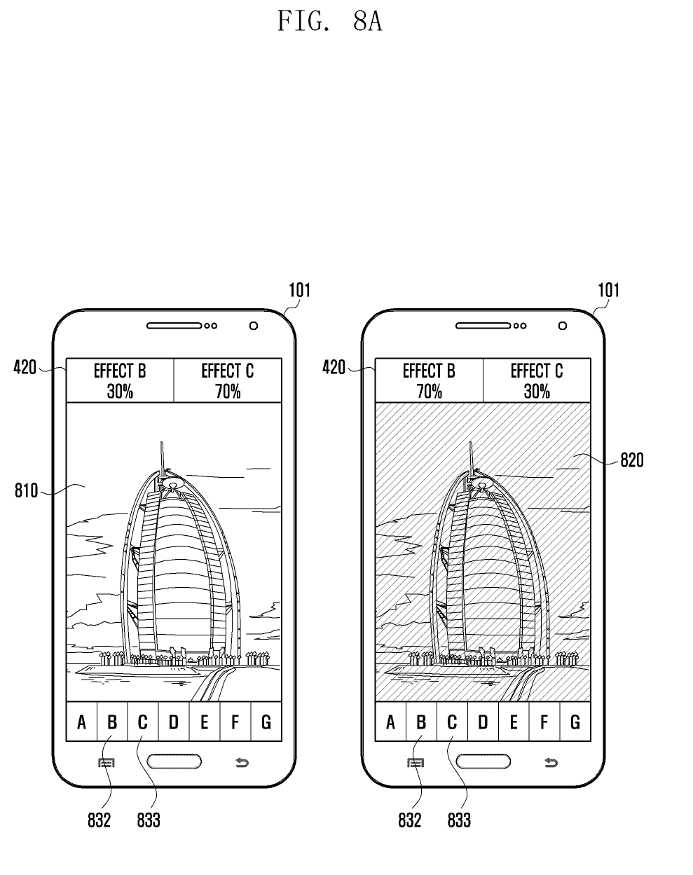

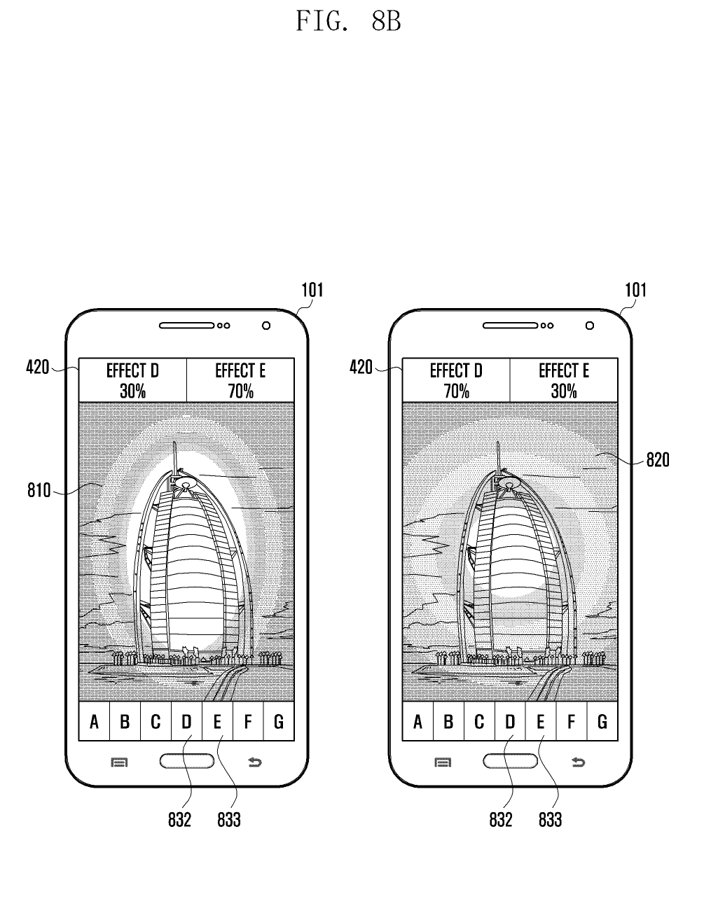

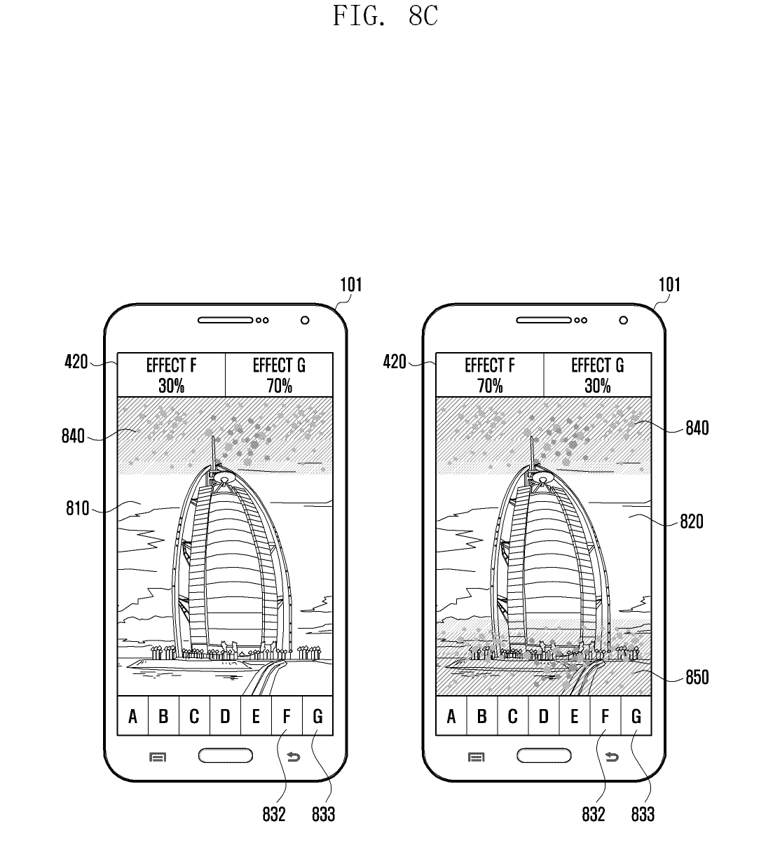

Each of the WiFi module 223, the BT module 225, the GNSS module 227, and the NFC module 228 may include, for example, a processor for processing data transmitted/received through the corresponding module. Although the cellular module 221, the WiFi module 223, the BT module 225, the GNSS module 227, and the NFC module 228 are illustrated as blocks separate from each other in FIG. 8, at least some (for example, two or more) of the cellular module 221, the WiFi module 223, the BT module 225, the GNSS module 227, and the NFC module 228 may be included in one Integrated Chip (IC) or one IC package according to one embodiment. For example, at least some (for example, the communication processor corresponding to the cellular module 221 and the WiFi processor corresponding to the WiFi module 223) of the processors corresponding to the cellular module 221, the WiFi module 223, the BT module 225, the GNSS module 227, and the NFC module 228 may be implemented by one SoC.

The RF module 229 transmits/receives data, for example, an RF signal. Although not illustrated, the RF module 229 may include, for example, a transceiver, a Power Amp Module (PAM), a frequency filter, a Low Noise Amplifier (LNA) or the like. Further, the RF module 229 may further include a component for transmitting/receiving electronic waves over a free air space in wireless communication, for example, a conductor, a conducting wire, or the like. Although the cellular module 221, the WiFi module 223, the BT module 225, the GNSS module 227, and the NFC module 228 share one RF module 229 in FIG. 2, at least one of the cellular module 221, the WiFi module 223, the BT module 225, the GNSS module 227, and the NFC module 228 may transmit/receive an RF signal through a separate RF module according to one embodiment.

The SIM card 224 is a card including a Subscriber Identification Module and may be inserted into a slot formed in a particular portion of the electronic device. The SIM card 224 includes unique identification information (for example, Integrated Circuit Card IDentifier (ICCID)) or subscriber information (for example, International Mobile Subscriber Identity (IMSI).

The memory 230 (for example, memory 130) may include an internal memory 232 and/or an external memory 234. The internal memory 232 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 200 through various interfaces. According to an embodiment, the electronic device 200 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor) 240H, a biometric (e.g., bio) sensor 240I, a temperature/humidity sensor 240J, an illumination (light) sensor 240K, and a Ultra Violet (UV) sensor 240M. Additionally or alternatively, the sensor module 240 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 may further include a control circuit for controlling one or more sensors included in the sensor module 240.

The input device 250 may include various input circuitry, such as, for example, and without limitation, a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 can recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which can detect an acoustic wave by a microphone (for example, microphone 288) of the electronic device 200 through an input means generating an ultrasonic signal to identify data and can perform wireless recognition. According to an embodiment, the electronic device 200 receives a user input from an external device (for example, computer or server) connected to the electronic device 200 by using the communication interface 220.

The display 260 (for example, display 160) includes a panel 262, a hologram device 264, and a projector 266. The panel 262 may be, for example, a Liquid Crystal Display (LCD) or an Active Matrix Organic Light Emitting Diode (AM-OLED), or the like, but is not limited thereto. The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 200. According to an embodiment, the display 260 may further include a control circuit for controlling the panel 262, the hologram device 264, and the projector 266.

The interface 270 may include various interface circuitry, such as, for example, and without limitation, a High-Definition Multimedia Interface (HDMI) 272, a Universal Serial Bus (USB) 274, an optical interface 276, and a D-subminiature (D-sub) 278. The interface 270 may be included in, for example, the communication interface 170 illustrated in FIG. 1. Additionally or alternatively, the interface 290 may include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 or the like.

The camera module 291 is a device which can photograph a still image and a video. According to an embodiment, the camera module 291 may include one or more image sensors (for example, a front sensor or a back sensor), an Image Signal Processor (ISP) (not shown) or a flash (for example, an LED or xenon lamp).

The power managing module 295 manages power of the electronic device 200. Although not illustrated, the power managing module 295 may include, for example, a Power Management Integrated Circuit (PMIC), a charger Integrated Circuit (IC), or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 296, or a voltage, a current, or a temperature during charging. The battery 296 may store or generate electricity and supply power to the electronic device 200 by using the stored or generated electricity. The battery 296 may include a rechargeable battery or a solar battery. The indicator 297 shows particular statuses of the electronic device 200 or a part (for example, AP 210) of the electronic device 200, for example, a booting status, a message status, a charging status and the like. The motor 298 converts an electrical signal to a mechanical vibration.

Although not illustrated, the electronic device 200 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

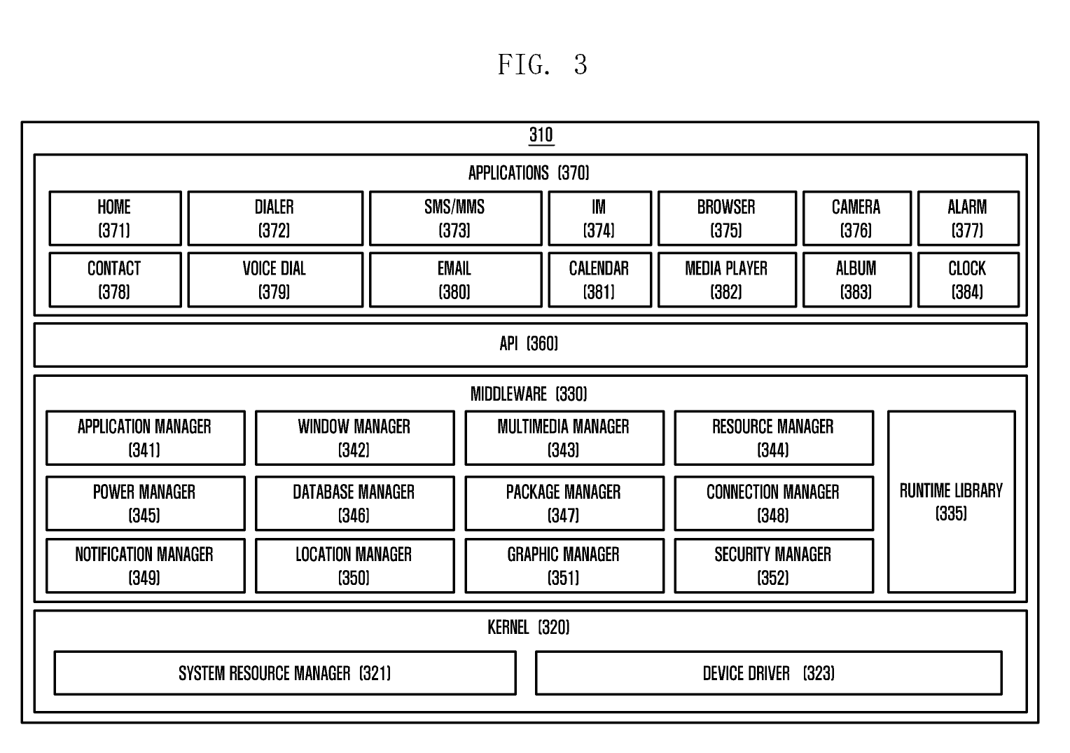

FIG. 3 is a block diagram illustrating an example programming module 310 according to an example embodiment. The programming module 310 (for example, programming module 140) may be included (stored) in the electronic device 100 (for example, memory 130) illustrated in FIG. 1. At least some of the programming module 310 may be formed of software, firmware, hardware, or a combination of at least two of software, firmware, and hardware. The programming module 310 may be executed in the hardware (for example, electronic device 200) to include an Operating System (OS) controlling resources related to the electronic device (for example, electronic device 100) or various applications (for example, applications 370) driving on the OS. For example, the OS may be Android, iOS, Windows, Symbian, Tizen, Bada or the like. Referring to FIG. 3, the programming module 310 includes a kernel 320, a middleware 330, an Application Programming Interface (API) 360, and applications 370.

The kernel 320 (for example, kernel 141) may include a system resource manager 321 and a device driver 323. The system resource manager 321 may include, for example, a process manager, a memory manager, and a file system manager. The system resource manager 321 performs a system resource control, allocation, and recall. The device driver 323 may include, for example, a display driver, a camera driver, a Bluetooth driver, a shared memory driver, a USB driver, a keypad driver, a WiFi driver, and an audio driver. Further, according to an embodiment, the device driver 323 may include an Inter-Process Communication (IPC) driver. The middleware 330 includes a plurality of modules prepared in advance to provide a function required in common by the applications 370.

Further, the middleware 330 provides a function through the API 360 to allow the application 370 to efficiently use limited system resources within the electronic device. For example, as illustrated in FIG. 3, the middleware 300 (for example, middleware 143) includes at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352. The runtime library 335 includes, for example, a library module used by a complier to add a new function through a programming language while the application 370 is executed. According to an embodiment, the runtime library 335 executes input and output, management of a memory, a function associated with an arithmetic function and the like. The application manager 341 manages, for example, a life cycle of at least one of the applications 370. The window manager 342 manages GUI resources used on the screen. The multimedia manager 343 detects a format required for reproducing various media files and performs an encoding or a decoding of a media file by using a codec suitable for the corresponding format. The resource manager 344 manages resources such as a source code, a memory, or a storage space of at least one of the applications 370.

The power manager 345 operates together with a Basic Input/Output System (BIOS) to manage a battery or power and provides power information required for the operation. The database manager 346 manages generation, search, and change of a database to be used by at least one of the applications 370. The package manager 347 manages an installation or an update of an application distributed in a form of a package file.

The connection manager 348 manages, for example, a wireless connection such as WiFi or Bluetooth. The notification manager 349 displays or notifies a user of an event such as an arrival message, an appointment, a proximity alarm or the like, in a manner that does not disturb the user. The location manager 350 manages location information of the electronic device. The graphic manager 351 manages a graphic effect provided to the user or a user interface related to the graphic effect. The security manager 352 provides a general security function required for a system security or a user authentication. According to an embodiment, when the electronic device (for example, electronic device 100 or 200) has a call function, the middleware 330 may further include a telephony manager for managing a voice of the electronic device or a video call function. The middleware 330 may generate a new middleware module through a combination of various functions of the aforementioned internal component modules and use the generated new middleware module. The middleware 330 may provide a module specified for each type of operating system to provide a differentiated function. Further, the middleware 330 may dynamically delete some of the conventional components or add new components. Accordingly, some of the components described in the embodiment of the present disclosure may be omitted, replaced with other components having different names but performing similar functions, or other components may be further included.

The API 360 (for example, API 145) is a set of API programming functions, and may be provided with a different configuration according to an operating system. For example, in Android or iOS, a single API set may be provided for each platform. In Tizen, two or more API sets may be provided.

The applications 370, which may include an application similar to the application 134, may include, for example, a preloaded application and/or a third party application. The applications 370 may include a home application 371 a dialer application 372, a Short Messaging Service (SMS)/Multlimedia Messaging Service (MMS) application 373, an Instant Messaging (IM) application 374, a browser application 375, a camera application 376, an alarm application 377, a contact application 378, a voice dial application 379, an email application 380, a calendar application 381, a media player application 382, an album application 383, and a clock application 384. However, the present embodiment is not limited thereto, and the applications 370 may include any other similar and/or suitable application. At least a part of the programming module 310 can be implemented by commands stored in computer-readable storage media. When the commands are executed by at least one processor, e.g. the AP 210, at least one processor can perform functions corresponding to the commands. The computer-readable storage media may be, for example, the memory 230. At least a part of the programming module 310 can be implemented, e.g. executed, by, for example, the AP 210. At least a part of the programming module 310 may include, for example, a module, a program, a routine, a set of instructions and/or a process for performing at least one function.

The titles of the aforementioned elements of the programming module, e.g. the programming module 300, according to the present disclosure may vary depending on the type of the OS. The programming module according to the present disclosure may include at least one of the aforementioned elements and/or may further include other additional elements, and/or some of the aforementioned elements may be omitted. The operations performed by a programming module and/or other elements according to the present disclosure may be processed through a sequential, parallel, repetitive, and/or heuristic method, and some of the operations may be omitted and/or other operations may be added.

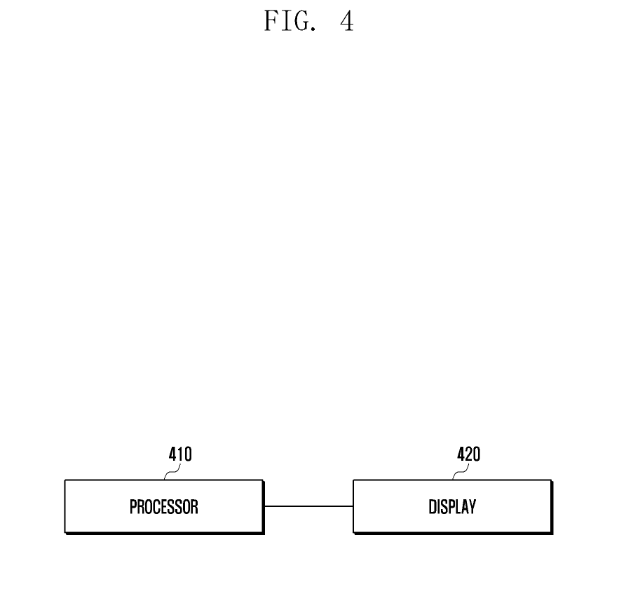

FIG. 4 is a block diagram illustrating an example electronic device according to various example embodiments of the present disclosure. The electronic device illustrated in FIG. 4 may be the electronic device 101 illustrated in FIG. 1, the electronic device 201 illustrated in FIG. 2, and the like.

As illustrated in FIG. 4, the electronic device may include, but not limited to, a processor (e.g., including processing circuitry) 410 and a display 420. In various embodiments, the electronic device may further include any other essential or optional elements. For example, the electronic device may be configured to include an input module (e.g., a touch panel, a hard key, a proximity sensor, a biosensor, etc.), a power supply unit, a memory, and/or the like.

According to various embodiments, the display 420 may be implemented in the form of a touch screen. The display 420 may be the display 160 illustrated in FIG. 1 or the display 260 illustrated in FIG. 2. The display 420 may be coupled with, for example, the input device 250 illustrated in FIG. 2. Also, the display 420 may be implemented as a touch screen, for example, in combination with the touch panel 252 shown in FIG. 2.

The display 420 may receive a touch, gesture, proximity, or hovering input, for example, using an electronic pen or a part of user's body. The display 420 may display various kinds of contents (e.g., images, videos, web pages, application execution screens, etc.), based on the control of the processor 410.

According to various embodiments, the display 420 may also display an image effect list that contains a plurality of image effects being applicable to the displayed contents, based on the control of the processor 410. The image effect may refer to changing the color, saturation, brightness, contrast, focus, etc. of the whole or part of an image.

The display 420 may display an image to which the image effect selected from the image effect list by the user is applied, based on the control of the processor 410. In addition, the display 420 may display an image to which a plurality of image effects selected from the image effect list by the user are simultaneously applied, based on the control of the processor 410.

The processor 410 may include various processing circuitry and control the display 420 to display an image and may also control the display 420 to display an image to which the above-mentioned image effect is applied. For example, the processor 410 may control the display 420 to display a first image or display a second image created by applying a selected image effect to the first image.

According to various embodiments, the processor 410 may manage a plurality of image effects. Managing the image effects may include, for example, storing the image effects in a memory (e.g., the memory 130 illustrated in FIG. 1 or the memory 230 illustrated in FIG. 2), reading out the image effects from the memory, and applying the image effects to an image. In addition, managing the image effects may further include deleting the image effect(s), downloading new image effect(s), creating a new image effect by combining the image effects, editing the image effect(s), and the like.

For example, the processor 410 may create and store the image effect list, based on a user's preference. For example, the processor 410 may select the image effects frequently used more than a predetermined number of times by the user, and register the selected image effects in the image effect list. In addition, the processor 410 may selectively delete the stored image effect(s) in response to a user's input of requesting deletion.

According to various embodiments, the processor 410 may combine a plurality of image effects into a single image effect in response to a user's input of requesting combination of image effects. Also, in response to corresponding user's inputs, the processor 410 may adjust a combining ratio between the plurality of image effects and adjust a level (e.g., the degree to be applied) of the combined image effects. For example, the processor 410 may display an image on the display 420 and display an image effect list that contains a first image effect and a second image effect. Then the processor 410 may adjust, in response to a first input, a combining ratio between the first and second image effects and also adjust, in response to a second input, a level of applying a third image effect created by combining the first and second image effects to the image.

The processor 410 may download image effects. For example, in response to a corresponding user's input, the processor 410 may download image effects from an external entity (e.g., a network, an email, a messenger, a detachable external memory, etc.). Further, the processor 410 may download data (e.g., image effect names, image effect icons, image effect types, etc.) associated with the downloaded image effects and manage the downloaded data with the image effects.

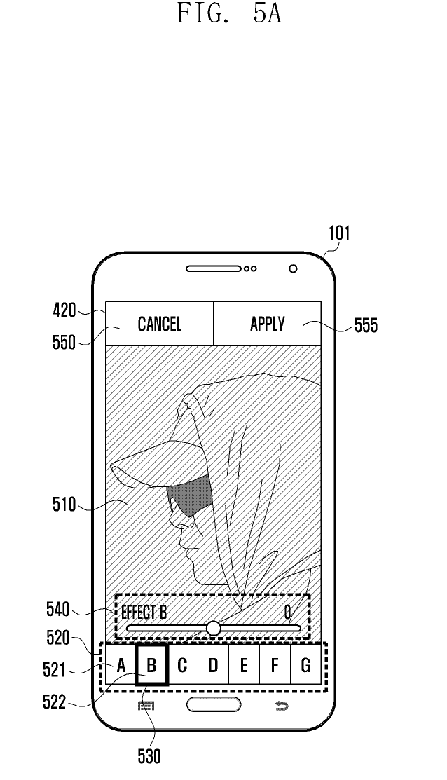

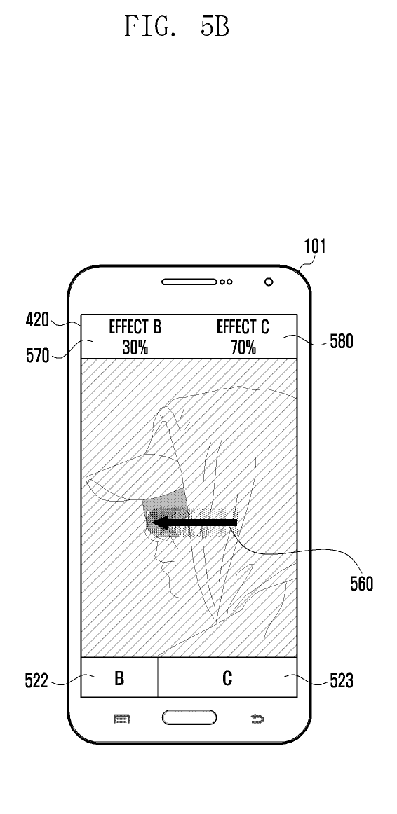

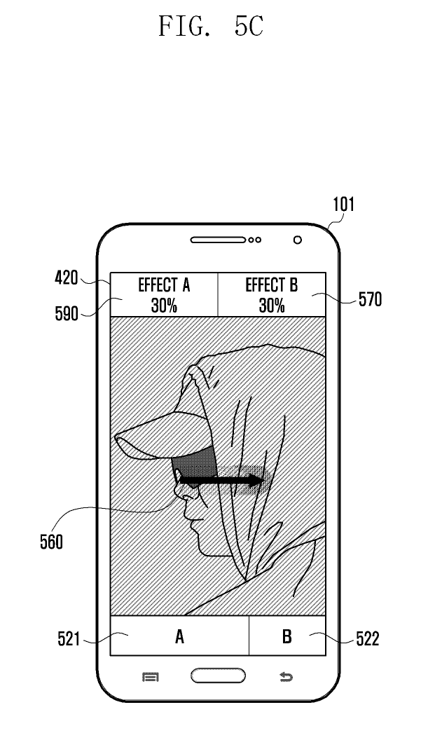

FIGS. 5A, 5B and 5C are diagrams illustrating an example process of combining image effects to be applied to an image in an electronic device according to various example embodiments of the present disclosure.

As illustrated in FIG. 5A, the electronic device 101 may display an image 510 on the display 420 and also display an image effect list 520 that is applicable to the image 510. The image effect list 520 may contain at least one or more image effects. The electronic device 101 may display such image effects by means of image effect names or icons representative of the image effects. Also, the electronic device 101 may apply the respective image effects to the image 510 displayed on the display 420.

According to various embodiments, the electronic device 101 may dispose the image effect list 520 horizontally at the bottom of the display 420. This is, however, an example only and not to be construed as a limitation. Alternatively, the electronic device 101 may dispose the image effect list 520 vertically at the right or left end of the display 420. If the display 420 has a bent portion at edges thereof, the electronic device 101 may display the image effect list 520 in the bent portion of the display 420. Meanwhile, the position of the image effect list 520 disposed on the display 420 may be changed by the user. If there is no selection for the image effect list 520 for a given time, the electronic device 101 may stop displaying the image effect list 520.

When an input, e.g., a user's input, e.g., a touch-and-drag input, occurs with regard to the image effect list 520, the electronic device 101 may newly display an image effect which is not displayed on the display 420. For example, when the image effect list 520 is displayed at the bottom of the display 420, the electronic device 101 may newly display non-displayed image effect(s) on the display 420 while moving all the image effects leftward or rightward in response to the touch-and-drag input.

Alternatively, when a user's input, e.g., a touch-and-swipe input, occurs with regard to the image effect list 520, the electronic device 101 may newly display an image effect which is not displayed on the display 420. For example, when the image effect list 520 is displayed at the bottom of the display 420, the electronic device 101 may newly display non-displayed image effect(s) on the display 420 while moving all the image effects leftward or rightward in response to the touch-and-swipe input.

The order of image effects displayed in the image effect list 520 may be changed. For example, if the user selects one of the displayed image effects through a long touch and then drags it, the electronic device 101 may move the position of the selected image effect according to the user's drag.

The electronic device 101 may display the image effect, selected by the user, distinctively from the unselected image effects. For example, the electronic device 101 may add a box mark 530 around the image effect 522 selected by the user, or add any other distinguishable mark (e.g., v) in the selected image effect 522.

When a certain image effect 522 is selected by the user, the electronic device 101 may display a user interface (UI) 540 for adjusting a level of applying the selected image effect 522 to the image 510. For example, when any image effect is selected by the user, the electronic device 101 may display a bar-shaped UI 540 capable of adjusting the level of the image effect on the display 420. Then the user may adjust the level while dragging an indicator in the bar-shaped UI 540.

The user may cancel applying the selected image effect 522 by selecting a “cancel” tab 550. Also, the user may determine applying the selected image effect 522 by selecting an “apply” tab 555.

As illustrated in FIGS. 5B and 5C, the electronic device 101 may combine a plurality of image effects.

According to various embodiments, in response to a user's first input, the electronic device 101 may combine the first image effect 522 and the second image effect 523 and may also adjust a combining ratio between the first and second image effects 522 and 523. The first input may include, for example, but not limited to, a touch input, a touch-and-drag input, a touch-and-swipe input, a physical key input, a hovering input, and the like. Hereinafter, it is assumed that the first input is a touch-and-drag input.

As illustrated in FIG. 5B, the user may create a first input 560 that touches and drags leftward on the display 420 after the first image effect 522 is selected. In response to the first input 560, the electronic device 101 may combine the second image effect 523, located at the right of the first image effect 522, with the first image effect 522. This is exemplary only and not to be construed as a limitation. Alternatively, in response to the first input 560 that touches and drags leftward on the display 420, the electronic device 101 may combine the second image effect 521, located at the left of the first image effect 522, with the first image effect 522.

In addition, the electronic device 101 may adjust a combining ratio between the first and second image effects 522 and 523, based on the length of the user's touch-and-drag input 560. For example, as the touch-and-drag input 560 moves longer in the left direction on the display 420, the electronic device 101 may increase a combining ratio of the second image effect 523.

According to various embodiments, in response to the user's first input 560, the electronic device 101 may display a current combining ratio between the image effects 522 and 523 as tab-shaped Uls 570 and 580 instead of the previously displayed cancel and apply tabs 550 and 555. For example, the electronic device 101 may display information respectively indicating the combining ratio 570 of the first image effect and the combining ratio 580 of the second image effect at the top of the display 420.

In addition, in response to the user's first input 560, the electronic device 101 may display only the currently combined image effects 522 and 523 rather than all the image effects contained in the image effect list 520. For example, the electronic device 101 may display, instead of the image effect list 520, only the first and second image effects 522 and 523 being currently applied to the image 510 at the bottom of the display 420. Also, the electronic device 101 may resize a tab for displaying each of the first and second image effects 522 and 523, based on the combining ratio between the first and second image effects 522 and 523.

As illustrated in FIG. 5C, the user may create the first input 560 that touches and drags rightward on the display 420 after the first image effect 522 is selected. In response to the first input 560, the electronic device 101 may combine the second image effect 521, located at the left of the first image effect 522, with the first image effect 522. This is exemplary only and not to be construed as a limitation. Alternatively, in response to the first input 560 that touches and drags rightward on the display 420, the electronic device 101 may combine the second image effect 523, located at the right of the first image effect 522, with the first image effect 522.

In addition, the electronic device 101 may adjust a combining ratio between the first and second image effects 522 and 521, based on the length of the user's touch-and-drag input 560. For example, as the touch-and-drag input 560 moves longer in the right direction on the display 420, the electronic device 101 may increase a combining ratio of the second image effect 521.

According to various embodiments, in response to the user's first input 560, the electronic device 101 may display a current combining ratio between the image effects 521 and 522 as tab-shaped Uls 590 and 570 instead of the previously displayed cancel and apply tabs 550 and 555. For example, the electronic device 101 may display information respectively indicating the combining ratio 570 of the first image effect and the combining ratio 590 of the second image effect at the top of the display 420.

In addition, in response to the user's first input 560, the electronic device 101 may display only the currently combined image effects 521 and 522 rather than all the image effects contained in the image effect list 520. For example, the electronic device 101 may display, instead of the image effect list 520, only the first and second image effects 522 and 521 being currently applied to the image 510 at the bottom of the display 420. Also, the electronic device 101 may resize a tab for displaying each of the first and second image effects 522 and 521, based on the combining ratio between the first and second image effects 522 and 521.

The screen that appears on the display 420 in response to the user's first input as illustrated in FIGS. 5B and 5C may be changed continuously according to the first input. For example, while the touch-and-drag input 560 is varied in length after being started, the electronic device 101 may continuously change the combining ratio between the first image effect 522 and the second image effect 523 or 521. Also, based on the combining ratio being continuously changed, the electronic device 101 may continuously change the combined image effects applied to the image 510 displayed on the display 420.

Such a change of the screen is not limited to a variation in length of the touch-and-drag input 560. According to another embodiment, while the touch-and-drag input 560 is varied in direction after being started, the electronic device 101 may continuously change the combining ratio between the first image effect 522 and the second image effect 523 or 521. Also, based on the combining ratio being continuously changed, the electronic device 101 may continuously change the combined image effects applied to the image 510 displayed on the display 420.

According to still another embodiment, while the touch-and-drag input 560 is varied in input time after being started, the electronic device 101 may continuously change the combining ratio between the first image effect 522 and the second image effect 523 or 521. Also, based on the combining ratio being continuously changed, the electronic device 101 may continuously change the combined image effects applied to the image 510 displayed on the display 420.

According to yet another embodiment in which the first input 560 is a touch input, while the touch input 560 is varied in input strength after being started, the electronic device 101 may continuously change the combining ratio between the first image effect 522 and the second image effect 523 or 521. Also, based on the combining ratio being continuously changed, the electronic device 101 may continuously change the combined image effects applied to the image 510 displayed on the display 420.

Similarly, in response to the first input, the electronic device 101 may change information displayed at the top and bottom of the display 420 to indicate the combining ratio between the image effects. For example, in parts (b) and (c) of FIG. 5, the electronic device 101 may change the combining ratio of the first image effect from 100% to 0% and simultaneously change the combining ratio of the second image effect from 0% to 100%.

For example, in FIGS. 5B and 5C, the electronic device 101 may gradually reduce the size of the tab for displaying the first image effect 522 at the bottom of the display 420 and may also gradually increase the size of the tab for displaying the second image effect 523 or 521.

Therefore, the user may check the result of actually applying the combined image effects to the image 510 displayed on the display 420 while adjusting the combining ratio between the combined image effects.

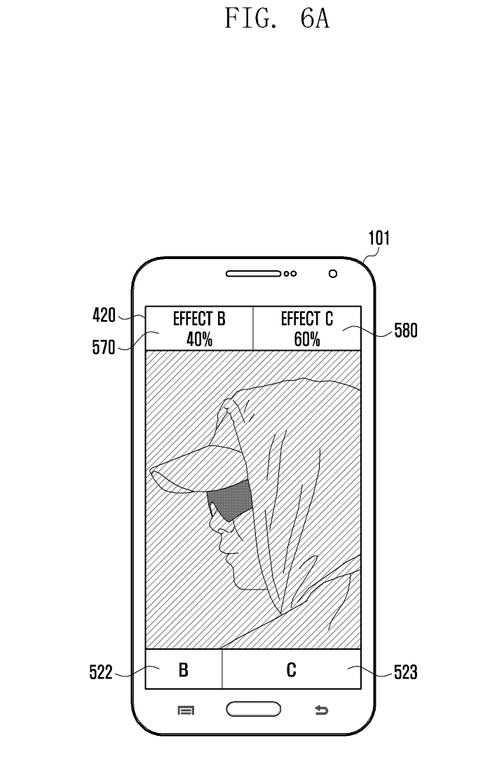

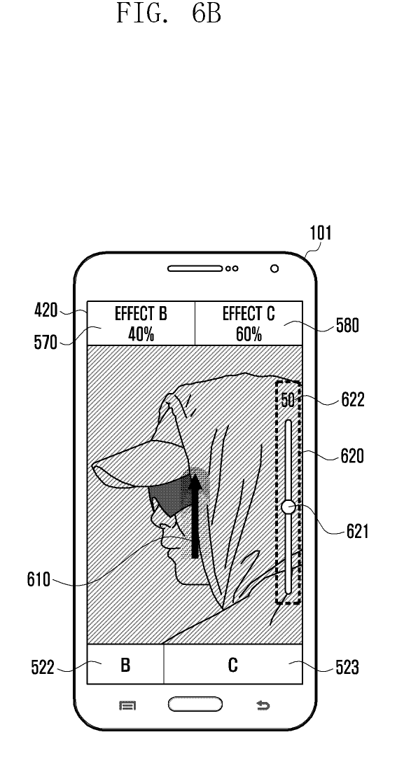

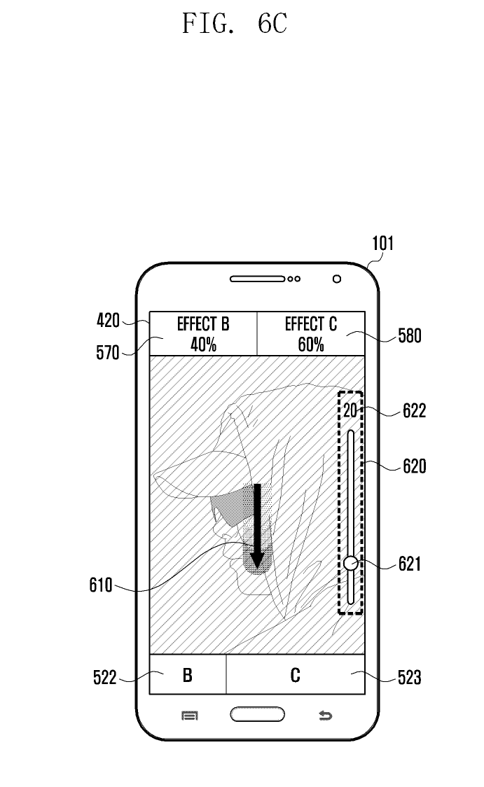

FIGS. 6A, 6B and 6C are diagrams illustrating an example process of adjusting a level of combined image effects in an electronic device according to various example embodiments of the present disclosure.

FIG. 6A may correspond to FIG. 5B or 5C. As illustrated in FIG. 6A, the electronic device 101 may combine the first image effect 522 and the second image effect 523 in response to the user's first input.

According to various embodiments, in response to the user's first input, the electronic device 101 may display information for indicating the combining ratio 570 of the first image effect and the combining ratio 580 or 590 of the second image effect at the top of the display 420.

Also, in response to the user's first input 560, the electronic device 101 may display only the first and second image effects 522 and 521 being currently applied to the image 510 at the bottom of the display 420. In this case, the electronic device 101 may resize a tab for displaying each of the first and second image effects 522 and 521, based on the combining ratio between the first and second image effects 522 and 521.

As illustrated in FIG. 6B, the user may create a second input 610 that touches and drags upward on the display 420 after the combining ratio between the first and second image effects 522 and 523 is determined. The second input may include, for example, but not limited to, a touch input, a touch-and-drag input, a touch-and-swipe input, a physical key input, a hovering input, and the like. Hereinafter, it is assumed that the second input is a touch-and-drag input.

In response to the user's second input 610, the electronic device 101 may adjust a level of applying a new image effect, created by combining the first and second image effects 522 and 523, to the image 510.

In addition, the electronic device 101 may adjust the level of the new image effect created by combining the first and second image effects 522 and 523, based on the length of the user's touch-and-drag input 610. For example, as the touch-and-drag input 610 moves longer in the upward direction on the display 420, the electronic device 101 may increase the level of the new image effect.

According to various embodiments, in response to the user's second input 610, the electronic device 101 may display a suitable UI 620 for indicating the level of the image effect to be applied to the image 510 on the display 420. For example, the electronic device 101 may display a vertically long bar-shaped UI 620 on the display 420. In this case, the electronic device 101 may display the level in the bar-shaped UI 620 in response to the user's second input. The shape and position of the UI 620 for indicating the level are exemplary only and not to be construed as a limitation.

Alternatively, the electronic device 101 may display the level of the image effect by using any other shaped UI such as a circular UI. If the display 420 has a bent portion at edges thereof, the electronic device 101 may display the UI 620 for indicating the level of the image effect in the bent portion of the display 420. The position of the UI 620 disposed on the display 420 may be changed by the user.

According to various embodiments, when the user's touch-and-drag input 610 moves upward on the display 420, the electronic device 101 may move upward an indicator 621 contained in the UI 620 for indicating the level of the image effect. Simultaneously or sequentially, the electronic device 101 may display a value 622 of the level near or in the UI 620 for indicating the level of the image effect.

As illustrated in FIG. 6C, the user may create the second input 610 that touches and drags downward on the display 420 after the combining ratio between the first and second image effects 522 and 523 is determined.

The electronic device 101 may adjust the level of the new image effect created by combining the first and second image effects 522 and 523, based on the length of the user's touch-and-drag input 610. For example, as the touch-and-drag input 610 moves longer in the downward direction on the display 420, the electronic device 101 may increase the level of the new image effect.

Also, in response to the user's second input 610, the electronic device 101 may display the UI 620 for indicating the level of the image effect to be applied to the image 510 on the display 420.

For example, when the user's touch-and-drag input 610 moves downward on the display 420, the electronic device 101 may move downward the indicator 621 contained in the UI 620 for indicating the level of the image effect. Simultaneously or sequentially, the electronic device 101 may display the level value 622 near or in the UI 620 for indicating the level of the image effect.

According to various embodiments, in response to the user's second input 610, the electronic device 101 may stop displaying the names of the combined image effects 522 and 523 previously displayed at the bottom of the display 420. This is, however, exemplary only. Alternatively, the electronic device 101 may continue to display the names of the combined image effects 522 and 523.

The screen that appears on the display 420 in response to the user's second input 610 as illustrated in FIGS. 6B and 6C may be changed continuously according to the second input 610. For example, while the touch-and-drag input 610 is varied in length after being started, the electronic device 101 may continuously change the level of the new image effect created by combining the first and second image effects 522 and 523. Also, based on the continuously changed level, the electronic device 101 may continuously change the new image effect applied to the image 510 displayed on the display 420.

Therefore, the user may check the result of actually applying the new image effect to the image 510 displayed on the display 420 while adjusting the level of the new image effect created by combining the image effects.

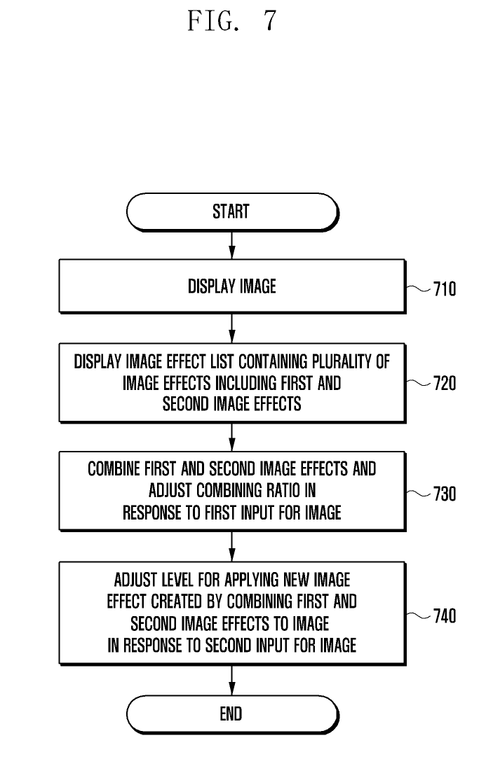

FIG. 7 is a flowchart illustrating an example method for combining a plurality of image effects and adjusting a level for applying the combined image effects to an image in an electronic device according to various example embodiments of the present disclosure.

At operation 710, the electronic device 101 may display an image. For example, the electronic device 101 may read out a stored image from the memory 130 or 230 and display it on the display 420. In another example, the electronic device 101 may display an image obtained through the camera module 291 on the display 420. In the latter case, the electronic device 101 may continuously process images obtained through the camera module 291 to display them. Namely, the images obtained through the camera module 291 and displayed on the display 420 may be changed continuously. Such an image obtained through the camera module 291 may be a preview image or a photographed image.

At operation 720, the electronic device 101 may display an image effect list that contains a plurality of image effects including first and second image effects. The electronic device 101 may display such image effects by means of image effect names or icons representative of the image effects. Also, the electronic device 101 may apply the respective image effects to the image displayed on the display 420.

The electronic device 101 according to various embodiments may display all image effects in the image effect list. However, if the number of image effects is greater than a predetermined number, the electronic device 101 may display only the predetermined number of image effects in the image effect list. In this case, the remaining image effects may appear in the image effect list when there is a suitable user's input.

In addition, the electronic device 101 may change the order of image effects displayed in the image effect list in response to a suitable user's input. Also, the electronic device 101 may display the image effect(s), selected by the user, distinctively from the unselected image effect(s).

At operation 730, in response to a first input for the displayed image, the electronic device 101 may combine the first image effect 522 and the second image effect 523 and may also adjust a combining ratio between the first and second image effects 522 and 523. The first input may include, for example, but not limited to, a touch input, a touch-and-drag input, a touch-and-swipe input, a physical key input, a hovering input, and the like. Hereinafter, it is assumed that the first input is a touch-and-drag input.

The electronic device 101 according to various embodiments may combine the first and second image effects, based on the first image effect selected by the user, in response to the user's first input. In addition, the electronic device 101 may adjust the combining ratio between the first and second image effects in response to the first input. For example, depending on the length of the first input (e.g., the touch-and-drag input), the electronic device 101 may adjust the combining ratio between the first and second image effects.

At operation 740, the electronic device 101 may adjust a level for applying a new image effect, created by combining the first and second image effects, to the displayed image in response to a second input for the displayed image. The second input may be the same as the above-discussed first input. Hereinafter, it is assumed that the second input is a touch-and-drag input.

The electronic device 101 according to various embodiments may adjust, depending on the length of the second input (e.g., the touch-and-drag input), the level of the new image effect created by combining the first and second image effects.

FIGS. 8A, 8B and 8C are diagrams illustrating example cases of combining a plurality of image effects in an electronic device according to various embodiments of the present disclosure. As illustrated in FIGS. 8A to 8C, the electronic device 101 may variously display an image depending on properties of the image effects to be combined.

As described above, in response to the user's first input, the electronic device 101 may combine the first and second image effects and also adjust the combining ratio. Then, based on the adjusted combining ratio between the first and second image effects, the electronic device 101 may change an image displayed on the display 420.

The first image 810 is, for example, a case where the combining ratio of the first image effect 832 to the second image effect 833 is adjusted to 30% to 70%. The second image 820 is, for example, a case where the combining ratio of the first image effect 832 to the second image effect 833 is adjusted to 70% to 30%.

As illustrated in FIG. 8A, the electronic device 101 may apply a new image effect, created by combining the first and second image effects 832 and 833, to the image 810 or 820 displayed on the display 420. Here, the first image effect 832 may mean, for example, changing the color, saturation, brightness, contrast, focus, etc. of the entire or part of the image.

The electronic device 101 may differently display the first image 810 and the second image 820, depending on the combining ratio between the first and second image effects 832 and 833. For example, in case of the second image 820 where the first image effect 832 is more applied, the electronic device 101 may reflect properties of the first image effect 832 much more. As a result, the second image 820 may be displayed with at least one of color, saturation, brightness, contrast, and focus changed much more in whole or in part compared to the first image 810.

As illustrated in FIG. 8B, the electronic device 101 may apply a new image effect, created by combining the first and second image effects 832 and 833, to the image 810 or 820 displayed on the display 420. Here, the first image effect 832 may be, for example, an image effect of less blurring the central portion of the image and much more blurring the peripheral portion of the image.

The electronic device 101 may differently display the first image 810 and the second image 820, depending on the combining ratio between the first and second image effects 832 and 833. For example, in case of the second image 820 where the first image effect 832 is more applied, the electronic device 101 may reflect properties of the first image effect 832 much more. As a result, the second image 820 may be displayed with a clearer central portion and a more blurred peripheral portion in comparison with the first image 810.

As illustrated in FIG. 8C, the electronic device 101 may apply a new image effect, created by combining the first and second image effects 832 and 833, to the image 810 or 820 displayed on the display 420. Here, the first image effect 832 may be, for example, an image effect of adding a given image to only a first portion in case of a lower level and adding the given image to both first and second portions in case of a higher level.

The electronic device 101 may differently display the first image 810 and the second image 820, depending on the combining ratio between the first and second image effects 832 and 833. For example, in case of the second image 820 where the first image effect 832 is more applied, the electronic device 101 may reflect properties of the first image effect 832 much more. As a result, the first image 810 may have the given image added to only the first portion 840, whereas the second image 820 may have the given image added to both the first and second portions 840 and 850.

As such, the electronic device 101 may alter and display the image in various ways in accordance with the properties of the image effects.

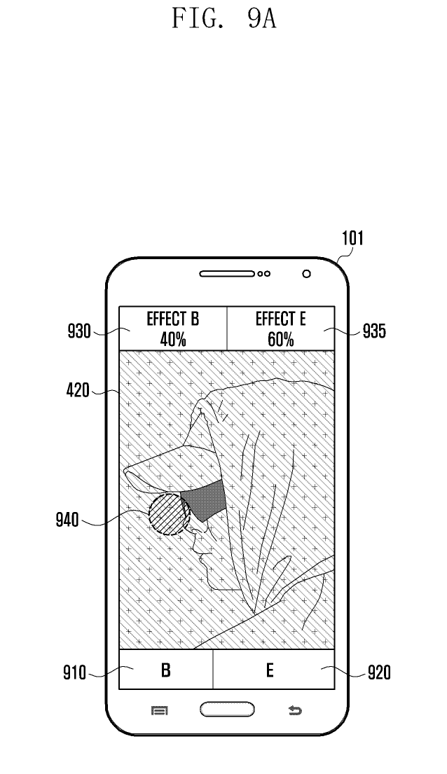

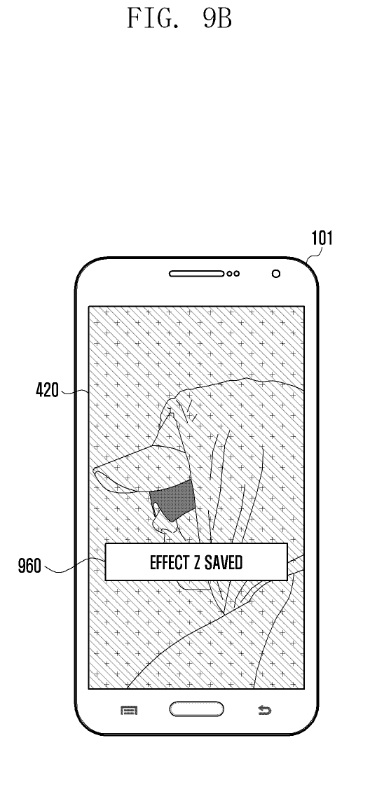

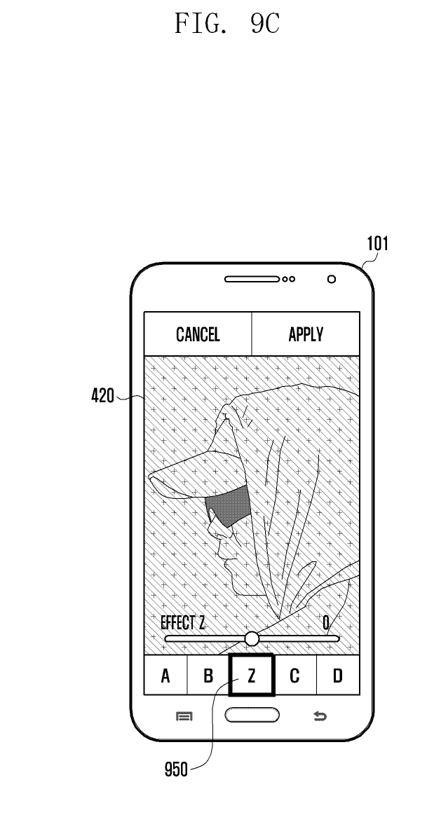

FIGS. 9A, 9B and 9C are diagrams illustrating an example process of storing a new image effect created by combining first and second image effects in an electronic device according to various example embodiments of the present disclosure.

FIG. 9A may correspond to FIG. 5B or 5C. As illustrated in FIG. 9A, the electronic device 101 may combine the first image effect 910 and the second image effect 920 in response to the user's first input.

According to various embodiments, in response to the user's first input, the electronic device 101 may display information for indicating the combining ratio 930 of the first image effect 910 and the combining ratio 935 of the second image effect 920 at the top of the display 420.

Also, in response to the user's first input, the electronic device 101 may display only the currently applied first and second image effects 910 and 920 at the bottom of the display 420. In this case, the electronic device 101 may resize a tab for displaying each of the first and second image effects 910 and 920, based on the combining ratio between the first and second image effects 910 and 920.

According to various embodiments, in response to the user's third input, the electronic device 101 may store the combined image effects, currently displayed on the display 420, as a new image effect. For example, when a long touch 940 is received from one point after the first or second input using a touch and drag, the electronic device 101 may recognize the long touch 940 as the user's third input.

As illustrated in FIG. 9B, in response to the long touch 940, the electronic device 101 may create and save a new image effect in which the first and second image effects 910 and 920 displayed on the display 420 are combined. In this case, the electronic device 101 may display on the display 420 a notification 960 for indicating that the new image effect Z 950 is completely saved.

As illustrated in FIG. 9C, the electronic device 101 may add the newly created image effect Z 950 in the image effect list. Thereafter, the user may apply the new image effect Z 950 to other images.

The name of the new image effect Z 950 may be arbitrarily generated by the electronic device 101. Also, the electronic device 101 may provide an option to modify the name of the new image effect Z 950.

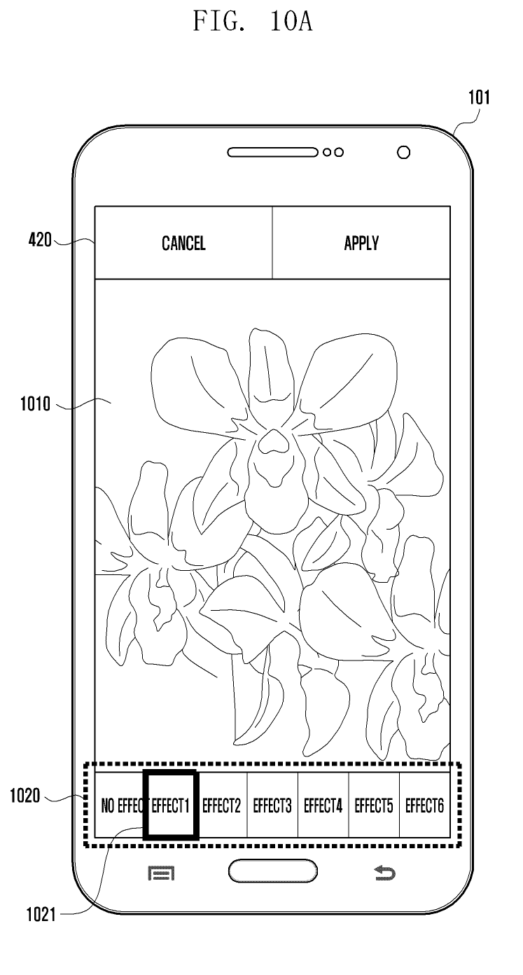

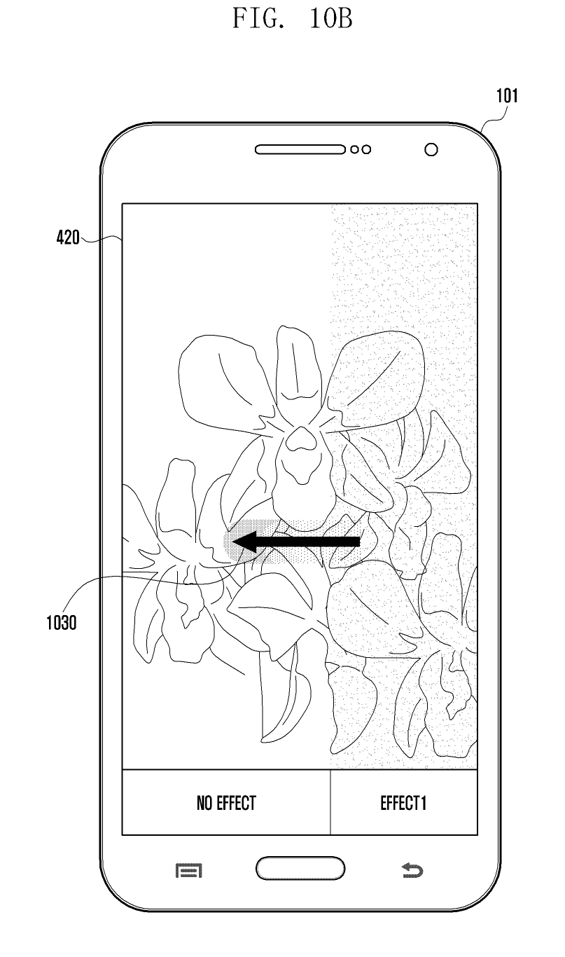

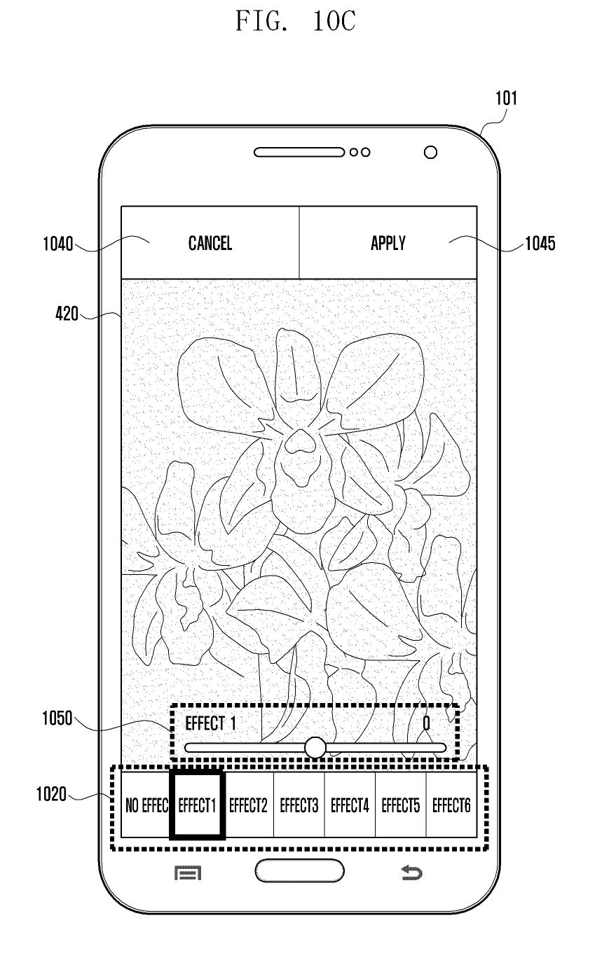

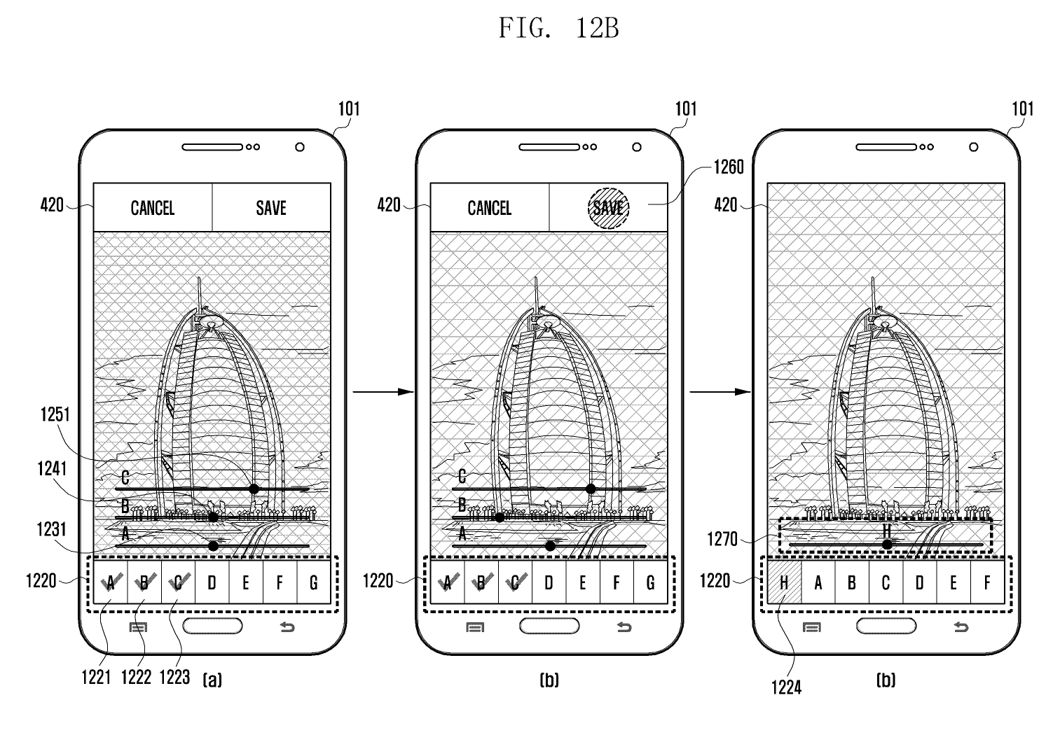

FIGS. 10A, 10B and 100 are diagrams illustrating an example process of applying an image effect to an image in an electronic device according to various example embodiments of the present disclosure.

As illustrated in FIG. 10A, the electronic device 101 may display an image 1010 on the display 420 and also display an image effect list 1020 that is applicable to the image 1010. The image effect list 1020 may contain at least one or more image effects. The electronic device 101 may display such image effects by means of image effect names or icons representative of the image effects. Also, the electronic device 101 may apply the respective image effects to the image 1010 displayed on the display 420.

According to various embodiments, the electronic device 101 may dispose the image effect list 1020 horizontally at the bottom of the display 420. When a user's input, e.g., a touch-and-drag input, occurs with regard to the image effect list 1020, the electronic device 101 may newly display an image effect which is not displayed on the display 420.

The order of image effects displayed in the image effect list 1020 may be changed. For example, if the user selects one of the displayed image effects through a long touch and then drags it, the electronic device 101 may move the position of the selected image effect according to the user's drag.

As illustrated in FIG. 10B, the electronic device 101 may apply a first image effect 1021 to the image 1010 displayed on the display 420. For example, the electronic device 101 may apply the first image effect 1021 to at least part of the image 1010 displayed on the display 420 in response to a user's fourth input. The fourth input may be, for example, an input similar to the first or second input described above.

According to various embodiments, the electronic device 101 may apply the first image effect 1021 to the image 1010 in response to the user's fourth input (e.g., a touch-and-drag input 1030) that moves leftward on the display 420. For example, the electronic device 101 may apply the first image effect 1021 to the image 1010 from a right portion of the display 420 in response to the touch-and-drag input 1030 moving leftward on the display 420. This is, however, exemplary only. Alternatively, the user's fourth input 1030 may be a touch-and-drag input that moves rightward, upward, or downward on the display 420.

Also, in response to the touch-and-drag input 1030, the electronic device 101 may display only the currently applied image effect 1021 rather than all the image effects contained in the image effect list 1020. For example, the electronic device 101 may display only the first image effect 1021 being currently applied to the image 1010 at the bottom of the display 420. Also, the electronic device 101 may resize a tab for displaying the first image effect 1021, based on an applied level of the first image effect 1021.

As illustrated in FIG. 100, the electronic device 101 may apply the first image effect 1021 to the entire area of the image 1010 displayed on the display 420.

According to various embodiments, when the touch-and-drag input 1030 starting from the right side of the display 420 and moving leftward arrives at the left end of the display 420, the electronic device 101 may apply the first image effect 1021 to the entire area of the image 1010.

After the first image effect 1021 is applied to the entire area of the image 1010 displayed on the display 420, the electronic device 101 may display a “cancel” tab 1040 and an “apply” tab 1045 at the top of the display 420. The user may cancel applying the selected image effect 1021 by selecting the “cancel” tab 1040, and may also determine applying the selected image effect 1021 by selecting the “apply” tab 1045.

According to various embodiments, when the first image effect 1021 is applied to the entire area of the image 1010 displayed on the display 420, the electronic device 101 may display the image effect list 1020 again at the bottom of the display 420. In addition, the electronic device 101 may display on the display 420 a suitable UI 1050 for adjusting a level of the currently applied image effect.

Through the above process, the user may simultaneously view a state of applying no image effect and a state of applying the image effect to the image.

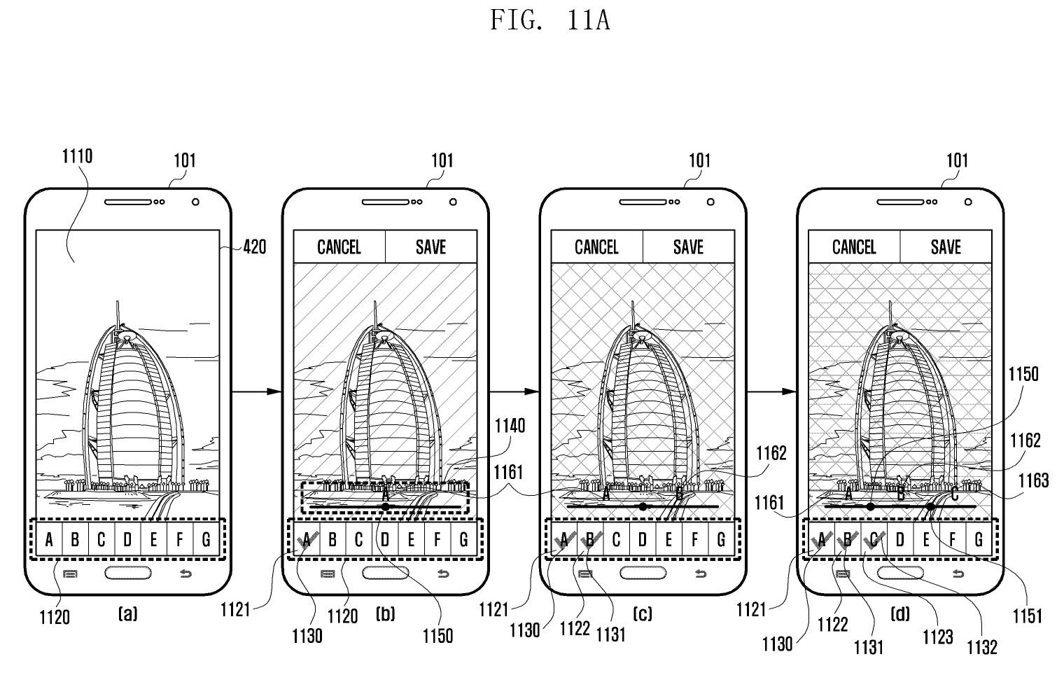

FIGS. 11A and 11B are diagrams illustrating example cases of combining three or more image effects in an electronic device according to various example embodiments of the present disclosure.

As illustrated in part (a) of FIG. 11A, the electronic device 101 may display an image 1110 on the display 420 and also display an image effect list 1120 that is applicable to the image 1110. The image effect list 1120 may contain at least one or more image effects.

According to various embodiments, the electronic device 101 may dispose the image effect list 1120 horizontally at the bottom of the display 420. When a user's input, e.g., a touch-and-drag input, occurs with regard to the image effect list 1120, the electronic device 101 may newly display an image effect which is not displayed on the display 420. The order of image effects displayed in the image effect list 1120 may be changed. Since part (a) of FIG. 11A is similar to part (a) of FIG. 5, a detailed description thereof will not be repeated.

As illustrated in part (b) of FIG. 11A, the electronic device 101 may display the image effect, selected by the user, distinctively from the unselected image effects. For example, the electronic device 101 may add a distinguishable mark 1130 (e.g., v) in an image effect 1121 selected by the user, or add a box mark around the selected image effect 1121.

When a certain image effect is selected by the user, the electronic device 101 may display a suitable UI for adjusting a level of applying the selected image effect to the image 1110. For example, when the first image effect 1121 is selected by the user, the electronic device 101 may display a bar-shaped UI 1140 capable of adjusting the level of the first image effect 1121 on the display 420. Further, the electronic device 101 may display a first indicator 1150 located in the bar-shaped UI 1140 to adjust the level and also display a name 1161 of the selected image effect. While dragging the first indicator 1150, the user may adjust the applied level of the selected image effect.

In this state, the user may select any other image effect to be combined with the preselected first image effect 1121, and may also adjust the combining ratio between the first image effect 1121 and the selected image effect.

As illustrated in part (c) of FIG. 11A, the electronic device 101 may display two marks 1130 and 1131 for indicating that two image effects 1121 and 1122 are selected by the user. After the image effects 1121 and 1122 are selected by the user, the electronic device 101 may display a suitable UI for adjusting the combining ratio between the selected first and second image effects 1121 and 1122.

For example, the electronic device 101 may add a name 1162 of the second image effect 1122 to the previously displayed bar-shaped UI 1140 for indicating the applied level of the first image effect 1121. In this case, the user may adjust the combining ratio between the first and second image effects 1121 and 1122 by moving the first indicator 1150.

As illustrated in part (d) of FIG. 11A, the electronic device 101 may display three marks 1130, 1131 and 1132 for indicating that three image effects 1121, 1122 and 1123 are selected by the user. After the image effects 1121, 1122 and 1123 are selected by the user, the electronic device 101 may display a suitable UI for adjusting the combining ratio among the selected first, second and third image effects 1121, 1122 and 1123.

For example, the electronic device 101 may add a second indicator 1151 and a name 1163 of the third image effect 1123 to the previously displayed bar-shaped UI 1140 for indicating the combining ratio between the first and second image effects 1121 and 1122. In this case, the user may adjust the combining ratio among the first, second and third image effects 1121, 1122 and 1123 by moving the first and second indicators 1150 and 1151.

As illustrated in part (a) of FIG. 11B, the user may adjust the combining ratio among the first, second and third image effects 1121, 1122 and 1123 by moving the first and second indicators 1150 and 1151.

Specifically, in the bar-shaped UI 1140 for adjusting the combining ratio of image effects, the length from the left end to the first indicator 1150 may indicate the combining ratio of the first image effect 1121. In addition, the length between the first and second indicators 1150 and 1151 may indicate the combining ratio of the second image effect 1122, and the length from the second indicator 1151 to the right end of the bar-shaped UI 1140 may indicate the combining ratio of the third image effect 1123.

Namely, while moving the indicators 1150 and 1151, the user may adjust the combining ratio between the respective image effects 1121, 1122 and 1123 within the total range of values capable of combining the selected image effects.

According to various example embodiments, the electronic device 101 may change continuously the image effects applied to the image 1110 displayed on the display 420, based on the combining ratio among the image effects 1121, 1122 and 1123 being varying according to the movement of the indicators 1150 and 1151. Therefore, the user may check the result of actually applying the combined image effects to the image 1110 displayed on the display 420 while adjusting the combining ratio among the combined image effects.

As illustrated in part (b) of FIG. 11B, the electronic device 101 may store the combined image effects, currently displayed on the display 420, as a new image effect. The electronic device 101 may store the new image effect when a “save” tab 1170 displayed at the top of the display 420 is selected, or may store the new image effect in response to the third input as described in part (b) of FIG. 9. The electronic device 101 may add the newly stored image effect 1124 to the image effect list 1120, and may display a suitable UI 1180 for adjusting a level of the new image effect 1124.

Part (c) of FIG. 11B illustrates another embodiment of the UI for adjusting the combining ratio among the selected first, second and third image effects 1121, 1122 and 1123. For example, the electronic device 101 may display a triangular UI 1190 instead of the previously displayed bar-shaped UI 1140 for indicating the combining ratio between the first and second image effects 1121 and 1122.

The triangular UI 1190 may have divided inner regions and display each image effect name in each region. Each inner region of the triangular UI 1190 may represent the combining ratio of each image effect. By moving a third indicator 1191, the user may adjust the region occupied by each of the first, second and third image effects 1121, 1122 and 1123. Based on sizes of such regions, the electronic device 101 may adjust the combining ratio among the first, second and third image effects 1121, 1122 and 1123. This UI 1190 is, however, exemplary only and not to be construed as a limitation.

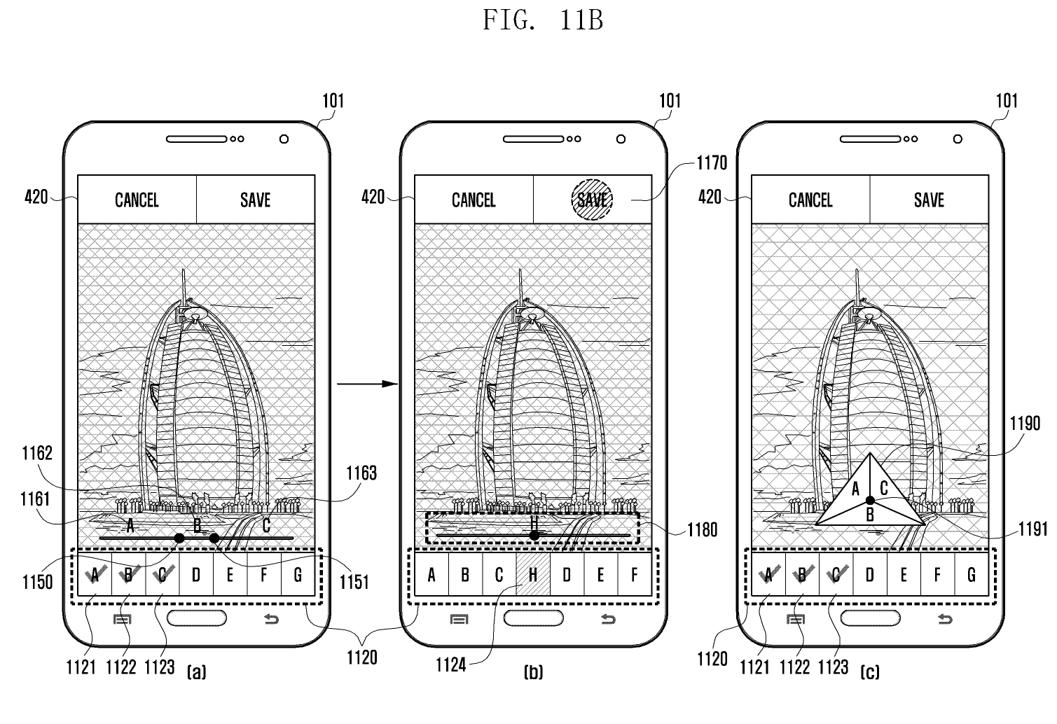

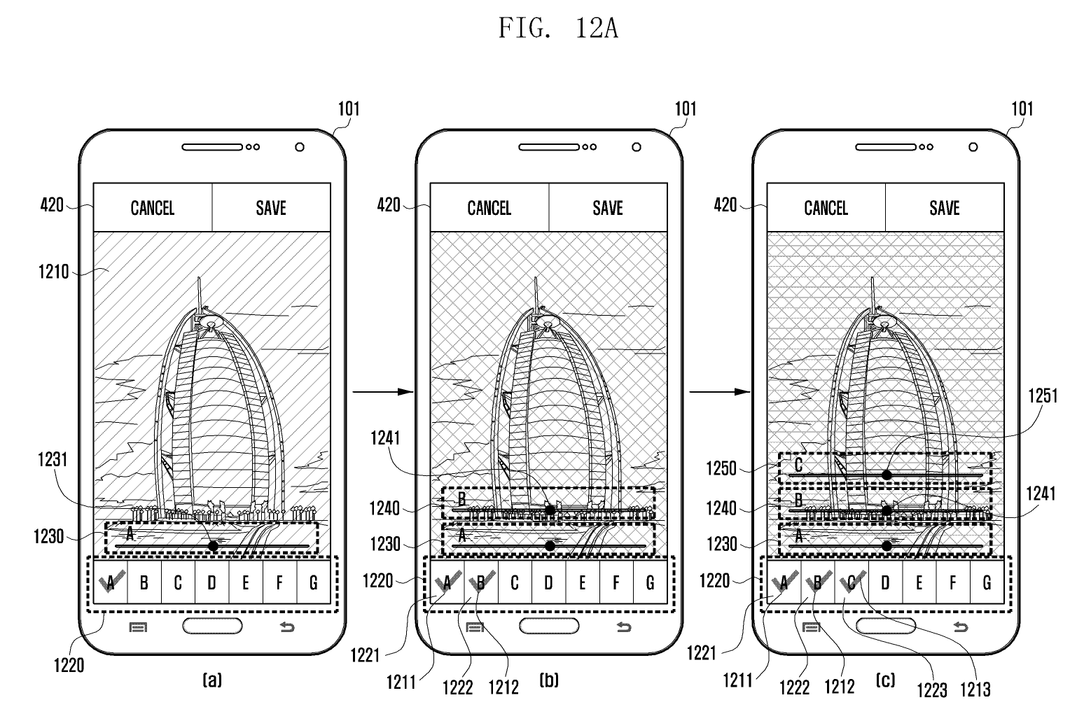

FIGS. 12A and 12B are diagrams illustrating other examples of combining three or more image effects in an electronic device according to various example embodiments of the present disclosure.

As illustrated in part (a) of FIG. 12A, the electronic device 101 may display an image 1210 on the display 420 and also display an image effect list 1220 that is applicable to the image 1210. According to various embodiments, the electronic device 101 may dispose the image effect list 1220 horizontally at the bottom of the display 420. The electronic device 101 may display the image effect, selected by the user, distinctively from the unselected image effects.

When the first image effect 1221 is selected by the user, the electronic device 101 may display a bar-shaped first UI 1230 for adjusting a level of applying the selected first image effect 1221 to the image 1210. Further, the electronic device 101 may display a first indicator 1231 located in the first UI 1230 to adjust the level and also display a name of the selected image effect. While dragging the first indicator 1231, the user may adjust the applied level of the selected image effect.

In this state, the user may select any other image effect to be combined with the preselected first image effect 1221, and may also adjust the combining ratio between the first image effect 1221 and the selected image effect.

As illustrated in part (b) of FIG. 12A, the electronic device 101 may display two marks 1211 and 1212 for indicating that two image effects 1221 and 1222 are selected by the user. After the image effects 1221 and 1222 are selected by the user, the electronic device 101 may display a second UI 1240 for adjusting the combining ratio of the second image effect 1222.

For example, the electronic device 101 may further display the second UI 1240 having the same bar shape as the first UI 1230 previously displayed for indicating the applied level of the first image effect 1221. The second UI 1240 may have a second indicator 1241. In this case, the user may adjust the combining ratio between the first and second image effects 1221 and 1222 by moving the first and second indicators 1231 and 1241.

As illustrated in part (c) of FIG. 12A, the electronic device 101 may display three marks 1211, 1212 and 1213 for indicating that three image effects 1221, 1222 and 1223 are selected by the user. After the image effects 1221, 1222 and 1223 are selected by the user, the electronic device 101 may display a third UI 1250 for adjusting the combining ratio of the third image effect 1223.

For example, the electronic device 101 may further display the third UI 1250 having the same bar shape as the first and second Uls 1230 and 1240 previously displayed for indicating the applied levels of the first and second image effects 1221 and 1222. The third UI 1250 may have a third indicator 1251. In this case, the user may adjust the combining ratio among the first, second and third image effects 1221, 1222 and 1223 by moving the first, second and third indicators 1231, 1241 and 1251.

As illustrated in parts (a) and (b) of FIG. 12B, the user may adjust the combining ratio among the first, second and third image effects 1221, 1222 and 1223 by moving the first, second and third indicators 1231, 1241 and 1251.

As illustrated in part (a) of FIG. 12B, the electronic device 101 may set the first and second image effects 1221 and 1222 at the same ratio and also set the third image effect 1223 at a greater ratio to combine the image effects 1221, 1222 and 1223. As illustrated in part (b) of FIG. 12B, the electronic device 101 may reduce the combining ratio of the second image effect 1222 from the previous ratio illustrated in part (a) of FIG. 12B and then combine the image effects 1221, 1222 and 1223. Namely, the user may individually adjust the combining ratio of each of the image effects 1221, 1222 and 1223 from 0% to 100%.

According to various embodiments, the electronic device 101 may change continuously the image effects applied to the image 1210 displayed on the display 420, based on the combining ratio among the image effects 1221, 1222 and 1223 being varying according to the movement of the indicators 1231, 1241 and 1251.

As illustrated in part (c) of FIG. 12B, the electronic device 101 may store the combined image effects, currently displayed on the display 420, as a new image effect. The electronic device 101 may store the new image effect when a “save” tab 1260 displayed at the top of the display 420 is selected, or may store the new image effect in response to the third input as described in part (b) of FIG. 9. The electronic device 101 may add the newly stored image effect 1224 to the image effect list 1220, and may display a suitable UI 1270 for adjusting a level of the new image effect 1224.

The term “module” used in this disclosure may refer, for example, to a certain unit that includes one of hardware, software, and firmware or any combination thereof. The module may be interchangeably used with unit, logic, logical block, component, or circuit, for example. The module may be the minimum unit, or part thereof, which performs one or more particular functions.

The module may be formed mechanically or electronically. For example, the module disclosed herein may include, for example, and without limitation, at least one of a dedicated processor, a CPU, an application-specific integrated circuit (ASIC) chip, field-programmable gate arrays (FPGAs), and programmable-logic device, which have been known or are to be developed.

At least part of the device (e.g., modules or functions thereof) or method (e.g., operations) according to various embodiments may be implemented as commands stored, e.g., in the form of a program module, in a computer-readable storage medium. In case commands are executed by a processor, the processor may perform a particular function corresponding to those commands. The computer-readable storage medium may be, for example, a memory. According to various embodiments, at least a part of the programming module may be implemented in software, firmware, hardware, or a combination of two or more thereof. At least some of the program module may be implemented (e.g., executed) by, for example, the processor. At least some of the program module may include, for example, a module, a program, a routine, a set of instructions, and/or a process for performing one or more functions. The non-transitory computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction. In addition, the program instructions may include high class language codes, which can be executed in a computer by using an interpreter, as well as machine codes made by a compiler.

A module or programming module according to various example embodiments may include or exclude at least one of the above-discussed components or further include any other component. The operations performed by the module, programming module, or any other component according to various embodiments may be executed sequentially, in parallel, repeatedly, or by a heuristic method. Additionally, some operations may be executed in different orders or omitted, or any other operation may be added.

While the disclosure has been described with reference to various example embodiments thereof, it will be understood that the various example embodiments are intended to be illustrative, not limiting. Accordingly, one skilled in the art will understand that various modifications, alternatives and/or variations of the example embodiments may be made without departing from the true spirit and full scope of the present disclosure as defined in the appended claims and their equivalents.

What is claimed is:

1. An electronic device comprising:
a display including a touch panel configured to receive a touch input; and
a processor electrically connected to the display,
wherein the processor is configured to control an image to be displayed on the display, to control an image effect list including first and second image effects to be displayed on the display, to adjust a combining ratio between the first and second image effects in response to a first input, and to change the displayed image based on the adjusted combining ratio.

2. The electronic device of claim 1, wherein the processor is further configured to adjust a level of applying the first and second image effects to the image in response to a second input.

3. The electronic device of claim 2, wherein each of the first and second inputs includes a touch-and-drag input.

4. The electronic device of claim 3, wherein the first input includes the touch-and-drag input in a first direction and the second input includes the touch-and-drag input in a second direction different from the first direction.

5. The electronic device of claim 1, wherein when changing the displayed image based on the adjusted combining ratio, the processor is further configured to differently change a first portion of the image and a second portion of the image different from the first portion, based on a combining ratio of the first image effect.

6. The electronic device of claim 1, wherein when changing the displayed image based on the adjusted combining ratio, the processor is further configured to change a first portion of the image and to not change a second portion of the image different from the first portion, based on a combining ratio of the first image effect.

7. The electronic device of claim 2, wherein the processor is further configured to create and store a third image effect by combining the first and second image effects in response to a third input.

8. The electronic device of claim 7, wherein the processor is further configured to display the third image effect together with the first and second image effects.

9. The electronic device of claim 1, wherein the image effect list further contains a third image effect, and
wherein the processor is further configured to adjust a combining ratio among the first, second and third image effects within a predetermined range.

10. The electronic device of claim 1, wherein the image effect list further contains a third image effect, and
wherein the processor is further configured to adjust a combining ratio by cumulatively applying the first, second and third image effects to the image.

11. An electronic device control method for combining a plurality of image effects, the method comprising:
displaying an image;
displaying an image effect list including first and second image effects;
adjusting a combining ratio between the first and second image effects in response to a first input; and
changing the displayed image based on the adjusted combining ratio.

12. The method of claim 11, further comprising:
adjusting a level of applying the first and second image effects to the image in response to a second input.

13. The method of claim 12, wherein each of the first and second inputs includes a touch-and-drag input.

14. The method of claim 13, wherein the first input includes the touch-and-drag input in a first direction and the second input includes the touch-and-drag input in a second direction different from the first direction.

15. The method of claim 11, wherein the changing the displayed image based on the adjusted combining ratio includes differently changing a first portion of the image and a second portion of the image different from the first portion, based on a combining ratio of the first image effect.

16. The method of claim 11, wherein the changing the displayed image based on the adjusted combining ratio includes changing a first portion of the image without changing a second portion of the image different from the first portion, based on a combining ratio of the first image effect.

17. The method of claim 12, further comprising:
creating and storing a third image effect by combining the first and second image effects in response to a third input.

18. The method of claim 11, further comprising:
when the plurality of image effects includes a third image effect,
adjusting a combining ratio among the first, second and third image effects within a predetermined range.

19. The method of claim 11, further comprising:
when the plurality of image effects includes a third image effect,
adjusting a combining ratio to cumulatively apply the first, second and third image effects to the image.

20. A non-transitory computer-readable recording medium having, recorded thereon, a program which, when executed by a processor of an electronic device, causes the electronic device to perform operations of for combining a plurality of image effects, the operations comprising:
displaying an image;
displaying an image effect list including first and second image effects;
adjusting a combining ratio between the first and second image effects in response to a first input; and
changing the displayed image based on the adjusted combining ratio.
